(19) United States
(12) Patent Application Publication
(10) Pub. No.: US 2021/0086142 A1
(43) Pub. Date: Mar. 25, 2021

(54) MEMBRANE

(71) Applicant: G20 Watere Technologies Limited, Manchester (GB)

(72) Inventor: Kangsheng Liu, Manchester (GB)

(21) Appl. No.: 16/954,358

(22) PCT Filed: Dec. 14, 2018
(86) PCT No.: PCT/GB2018/053633

§ 371 Date: Jun. 16, 2020

(30) Foreign Application Priority Data
Dec. 19, 2017 (GB) 1721320.8

(51) Int. Cl. B01D 71/02; B01D 69/02; B01D 69/10; B01D 69/14; B01D 67/00

(52) U.S. Cl. CPC B01D 71/022; B01D 69/02; B01D 69/10; B01D 69/141; B01D 2323/36; B01D 67/0069; B01D 2325/021; B01D 2325/36; B01D 2323/12; B01D 67/0095

(57) ABSTRACT

A filtration membrane, suitably for water filtration, in which the membrane includes a porous substrate layer and an active layer arranged over at least a part of the substrate layer. The active layer has a lamellar structure comprising at least two layers of two-dimensional material. The two-dimensional material comprises transition metal dichalcogenide. There is also provided methods for making the filtration membranes and compositions for use in those methods.

### FIELD

The present invention relates to membranes. More specifically, the present invention relates to membranes comprising metal dichalcogenide layers for water purification.

### BACKGROUND

Conventional methods of water purification such as chemical disinfection, solar disinfection, boiling, sedimentation and distillation are not sufficient to meet portable water requirement of the world's population at low cost. In order to tackle the problem, more advanced technologies have been established and industrialised, such as pressure driven-membrane based water purification technologies which in general include ultrafiltration (UF), microfiltration (MF), nanofiltration (NF), and reverse osmosis (RO). By providing the advantages of circumventing the application of thermal inputs, chemical additives and reducing medium regeneration, these methods have significantly improved water treatment industry. However, is it still desirable to provide functional membranes with further improved properties such as high sieving electivity, low energy cost, and higher water flux rate for sustainable water treatment and modern water purification industry.

Transition metal dichalcogenide materials can provide two-dimensional structures that may be of use in water treatment. However, these materials can present problems in relation to scalability of making membranes containing such materials, as well the high cost of the manufacturing processes.

Properties of membranes for water treatment should include high mechanical and thermal stability, good chemical and fouling resistance with cleanability, expanded life span, high controllable sieving selectivity and high permeability for desired molecule separation. Membranes should also be commercially accessible, such as, requiring low energy input, low material and manufacturing costs, high industrial scalability, and reasonable lead periods to commercialisation.

Therefore, there is a requirement for improved membranes for efficient water treatment. It is therefore an object of aspects of the present invention to address one or a few of the problems mentioned above or other problems.

### SUMMARY

According to a first aspect of the present invention, there is provided a filtration membrane, suitably for water filtration, water desalination and molecule separation, ion sieving selection, and/or protein separation; the membrane comprising a porous substrate layer and an active layer arranged over at least a part of the substrate layer, wherein the active layer has a lamellar structure comprising at least two layers of two-dimensional material, and wherein the two-dimensional material comprises transition metal dichalcogenide.

According to a second aspect of the present invention there is provided a method of producing a filtration membrane, suitably a membrane according to the first aspect of the present invention, wherein the membrane comprises a porous substrate layer and an active layer arranged over at least a part of the substrate layer, wherein the active layer has a lamellar structure comprising at least two layers of two dimensional material, and wherein the two-dimensional material comprises transition metal dichalcogenide, the method comprising the steps of:
a. optionally preparing the substrate
b. contacting the substrate with a composition comprising the transition metal dichalcogenide;
c. optionally, drying the membrane.

According to a third aspect of the present invention, there is provided a filtration membrane, suitably a membrane according to the first aspect of the present invention, wherein the membrane comprises a porous substrate layer and an active layer arranged over at least a part of the substrate layer, wherein the active layer has a lamellar structure comprising at least two layers of two dimensional material, and wherein the two-dimensional material comprises transition metal dichalcogenide, the method comprising the steps of:
a. optionally preparing the substrate
b. contacting the substrate with a composition comprising the transition metal dichalcogenide;
c. optionally, drying the membrane.

According to a further aspect of the present invention there is provided a method of producing a filtration membrane, suitably a membrane according to any other aspect of the present invention, wherein the membrane comprises a porous substrate layer and an active layer arranged over at least a part of the substrate layer, wherein the active layer has a lamellar structure comprising at least two layers of two dimensional material, and wherein the two-dimensional material comprises transition metal dichalcogenide, the method comprising the steps of:
a. optionally treating the substrate
b. printing a coating composition comprising the transition metal dichalcogenide, onto the substrate;
c. optionally, drying the membrane.

According to a further aspect of the present invention there is provided a method of producing a filtration membrane, suitably a membrane according to any other aspect of the present invention, wherein the membrane comprises a porous substrate layer and an active layer arranged over at least a part of the substrate layer, wherein the active layer has a lamellar structure comprising at least two layers of two dimensional material, and wherein the two-dimensional material comprises transition metal dichalcogenide, the method comprising the steps of:
a. optionally treating the substrate
b. deposition, such as gravity, vacuum or pressure deposition, of a coating composition comprising the transition metal dichalcogenide onto the substrate;
c. optionally, drying the membrane.

According to a further aspect of the present invention there is provided a coating composition for use in the manufacture of filtration membranes, suitably for use in the gravity/pressure/vacuum deposition or printing of filtration membranes, the composition comprising a transition metal dichalcogenide.

The substrate layer of any aspect of the present invention may comprise any porous material operable to support the active layer during the filtration process. The substrate may comprise one layer or multiple layers.

The substrate may be formed from material such as porous films, porous plates, hollow fibres, and bulky shapes. Suitably the substrate is formed from a porous film.

The porous film may be selected from inorganic porous films, organic porous films and inorganic-organic porous films.

An inorganic porous film may be formed from materials selected from one or more of zeolite, silicon, silica, alumina, zirconia, mullite, bentonite and montmorillonite clay substrate.

An organic porous film may be formed from materials selected from one or more of polyacrylonitrile (PAN), polyamide (PA), Poly(ether) sulfone (PES), cellulose acetate (CA), poly(piperazine-amide), polyvinylidene fluoride (PVDF), polytetrafluoroethylene (PTFE), poly(phthalazinone ether sulfone ketone) (PPESK), polyamide-urea, poly (ether ether ketone), polypropylene, poly(phthalazinone ether ketone), and thin film composite porous films (TFC), suitably the TFC comprises an ultra-thin ‘barrier’ layer polymerised in situ over a porous polymeric support membrane, such as commercially available polyamide derived TFCs of an interfacially synthesized polyamide formed over a polysulphone membrane, and/or others TFCs such as poly(piperazine-amide)/poly(vinyl-alcohol) (PVA), poly(piperazine-amide)/poly(phthalazinone biphenyl ether sulfone (PPBES), hydrolyzed cellulose tri-acetate (CTA)/Cellulose acetate (CA) TFCs.

The porous film may be a nanotechnology-based porous film, such as nanostructured ceramic porous films, inorganic-organic porous films and/or non-woven nano porous fabric.

The nanostructured ceramic porous film may be formed of a layer of membranes, suitably conventional pressure driven membranes/plates, with zeolite, titanium oxide, alumina, zirconia, etc., suitably synthesized zeolite, titanium oxide, alumina, on top of it such as via hydrothermal crystallisation or dry gel conversion methods. Other nanostructured ceramic porous films are reactive or catalyst coated ceramic surfaced substrates. Such substrates may advantageously lead to strong interaction with the active layer and improve the stability of the filters.

Inorganic-organic porous films containing mixed matrix membranes may be formed from inorganic particles contained in a porous organic polymeric film. An inorganic-organic porous film may be formed from materials selected from zirconia nanoparticles with polysulphone porous membrane. Advantageously, an inorganic-organic porous film may provide a combination of an easy to manufacture low cost substrate having good mechanical strength. An inorganic-organic porous film, such as zirconia nanoparticles with polysulphone may advantageously provide elevated permeability. Other inorganic-organic porous films may be selected from thin film nanocomposite membranes comprising one or more type of inorganic particle.; metal based (aluminium foam, copper foam, Pb foam, zirconium foam and Sn foam, gold foam; mixed matrix substrates comprising inorganic fillers in an organic matrix to form organic-inorganic mixed matrix.

The porous substrate may comprise a non-woven nano fabric. Advantageously, a non-woven nano fabric provides high porosity, high surface area, and/or controllable functionalities. The non-woven fabric may comprise fibres with diameter at nanoscale. The non-woven fabric may be formed of cellulose acetate, polyethylene terephthalate (PET), polyolefins such as polyethylene and polypropylene, and/or polyurethane, suitably by electrospinning, suitably using cellulose acetate, polyurethane, etc.

The substrate may be manufactured as flat sheet stock, plates or as hollow fibres and then made into one of the several types of membrane substrates, such as hollow-fibre substrate, or spiral-wound membrane substrate. Suitable flat sheet substrates may be obtained from Dow Filmtec and GE Osmonics.

Advantageously, a substrate in the form of a porous polymeric film can provide improved ease in processing and/or low cost.

Advantageously, a membrane comprising transition metal dichalcogenide and a porous ceramic substrate, such as a film or plate, can provide high thermal and chemical stability, such as working at high temperature, such as higher than 800° C.

The substrate layer may have any suitable pore size. The average size of the pores of the substrate may be from 0.1 nm 5 um depending on application, preferably from 0.1 to 1000 nm. The substrate is typically a microporous membrane or an ultrafiltration membrane, preferable an ultrafiltration membrane. The pore size of the substrate layer may be from 0.1 nm to 4000 nm, such as ≤3000 nm, or ≤2000 nm, ≤1000 nm or ≤500 nm, such as ≤250 nm, ≤100 nm, ≤50 nm or ≤1 nm. Preferably, the pore size of the substrate is smaller than the average size of the particles of the two-dimensional material. For example, should the transition metal dichalcogenide be in the form of flakes having average size of 200 nm, the pore size of the porous substrate is up to 120% of the average size of the transition metal dichalcogenide, which is up to 240 nm. Suitably, the pore size of the porous substrate is smaller than average size of the flakes of the transition metal dichalcogenide, such as up to 100% or up to 90% or up to 80% of the average size of the transition metal dichalcogenide.

The substrate layer may have any suitable thickness. The thickness of the substrate layer may be between 5 to 1000 μm, such as between 5 to 500 μm, or between 10 to 250 μm, or between 30 and 150 μm, preferably between 30 and 100 μm more preferably between 30 and 90 μm, such as between 30 and 80 μm, or between 30 and 70 μm, such as between 30 and 60 μm. Optionally, the substrate layer may have a thickness of between 5 and 30 μm, such as between 8 and 25 μm or between 8 and 20 μm, preferably between 10 and 15 μm. Suitably the substrate is selected from a a polysulphone substrate and/or a ceramic substrate.

The substrate may have a surface roughness, suitably Rz, such as from 0 to 1 μm, such as <500 nm or <300 nm, for example <200 nm or <100 nm, preferably <70 nm or <50 nm, more preferably <30 nm. Advantageously, low surface roughness can provide improved uniformity of the structure in the active layer.

The surface of the substrate operable to receive the active layer may be hydrophilic. Suitably, contact angle of the coating composition on the substrate surface is <90°, such as <70° and preferably <50°.

For polymeric substrates the substrate may be treated prior to the addition of the coating composition. A surface of the substrate operable to receive the coating composition may have been subjected to hydrophilisation. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. The grafting of functional groups may be by plasma treatment, redox reaction, radiation, UV-ozone treatment, and/or chemical treatment. Hydrophilic additives may be selected from polyvinyl alcohol, polyethylene glycol, nanofillers, surface modifying macromolecules and zwitterions. The addition of hydrophilic additives may be carried out by coating or depositing additives with desired functionality on the membrane surface.

Advantageously, surface treatment of polymeric substrates can provide improved uniformity of the active layer on the membrane. Surface treatment can also improve properties including the antifouling performance of the membrane, enhanced salt rejection and/or enhanced molecule selectivity and/or enhanced permeability. Fouling is a phenomenon of declining in flux and the life-span of a membrane due to different types of fouling, such as organic fouling, biofouling, and colloidal fouling.

For ceramic and metallic substrates, the substrate is preferably not treated.

The active layer of any aspect of the present invention may have a thickness of from 2 nm to 1000 nm, such as from 3 to 800 nm or from 4 to 600 nm, such as 5 to 400 nm or 5 to 200 nm, preferably 5 to 150 nm or 5 to 100 nm.

The transition metal dichalcogenide of any aspect of the present invention may be according to formula (I)

MₐX_{b}, (I)

wherein with M is a transition metal atom, such as Mo, W, Nb and Ni;
X is a chalcogen atom, preferably S, Se, or Te;
wherein 0<a≤1 and 0<b≤2.

The transition metal dichalcogenide of any aspect of the present invention be selected from one or more of MoS₂, MoSe₂, WS₂, WSe₂, MoₐW₁₋ₐS₂, MoₐW₁₋ₐSe₂, MoS_{b}Se_{2-b}, WS_{b}Se_{2-b}, or MoₐW₁₋ₐS_{b}Se_{2-b}, where 0<a≤1 and 0<b≤2, or combination thereof. Preferably, the transition metal dichalcogenide is selected from MoS₂, WS₂, MoSe₂, WSe₂. Most preferably from MoS₂ and WS₂. Such transition metal dichalcogenide is available commercially from ACS Material.

The transition metal dichalcogenide according to any aspect of the present invention may be in the form of flakes having an average size of from 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm. Suitably, the size distribution of the transition metal dichalcogenide flakes is such that at least 30 wt % of the transition metal dichalcogenide flakes have a diameter of between 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm more preferably at least 40 wt %, 50 wt %, 60 wt %, 70 wt % and most preferably at least 80 wt % or at least 90 wt % or 95 wt % or 98 wt % or 99 wt %. The size of the transition metal dichalcogenide thereof and size distribution may be measured using transmission electron microscopy (TEM, JEM-2100F, JEOL Ltd. Japan).

For example, lateral sizes of the two-dimensional layers across a sample may be measured using transmission electron microscopy (TEM, JEM-2100F, JEOL Ltd. Japan), and the number (Nᵢ) of the same sized nanosheets (Mᵢ) measured. The average size may then be calculated by Equation 1:

$$Average size = {\sum }_{i = 1}^{∞} {N}_{i} {M}_{i} / {\sum }_{i = 1}^{∞} {N}_{i}$$

where Mᵢ is diameter of the nanosheets, and Nᵢ is the number of the size with diameter Mᵢ.

The transition metal dichalcogenide may be in the form of a monolayer or multi-layered particle or flake, preferably a monolayer. The transition metal dichalcogenide flakes may be formed of single, two or few layers of transition metal dichalcogenide, wherein few may be defined as between 3 and 100 layers. Suitably, the transition metal dichalcogenide flakes comprise between 1 to 100 layers, such as between 2 to 75 layers or 5 to 50 layers or 10 to 25 layers. Suitably, at least 30 wt % of the transition metal dichalcogenide comprise between 1 to 30 layers, such as between 5 to 30 layers or 5 to 10 layers, more preferably at least 40 wt %, 50 wt %, 60 wt %, 70 wt % and most preferably at least 80 wt % or at least 90 wt % or 95 wt % or 98 wt % or 99 wt %. The number of layers in the transition metal dichalcogenide flakes thereof may be measured using atomic force microscopy (AFM or transmission electron microscopy (TEM)) (TT-AFM, AFM workshop Co., CA, USA).

Suitably, the d-spacing between adjacent lattice planes in the transition metal dichalcogenide or mixture thereof is from 0.34 nm to 5000 nm, such as from 0.34 nm to 1000 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example 0.6 to 2.5 nm, 0.6 to 1 nm, 0.6 to 2 nm, or 0.6 to 1.5 nm.

The average size of the transition metal dichalcogenide may be at least 80% of the average pore size of the substrate. For example, for average pore size of the substrate of 200 nm, the flake may have an average size of at least 160 nm. Suitably, the average size of the transition metal dichalcogenide is equal to or larger than the average pore size of the porous substrate, such as at least 100%, or at least 110%, or at least 120% of the average pore size of the substrate.

The active layer may comprise materials, suitably two-dimensional materials, other than the transition metal dichalcogenide thereof. For example, other materials of the active layer may be selected from one or more of silicene, germanene, stanene, boron-nitride, suitably h-boron nitride, carbon nitride, metal-organic nanosheets, graphene, graphene oxide, reduced graphene oxide functionalised graphene oxide and polymer/graphene aerogel.

The active layer may comprise additives to tailor the properties of the active layer, such as other metals; and/or fibres, such as metal oxide nanostrands; and/or dopants, e.g. Au, Fe, Cu, Cu(OH)₂, Cd(OH)₂ and Zr(OH)₂. Such additives may be added to the membrane to control the interlayer distance and/or create nanochannels for high water flux rate. Any type of suitable fibres, such as continuous or chopped fibres, having diameter of 0.5-1000 nm may be incorporated within the membrane. Preferably, the fibres are removed before use, such as by mechanical removal or by dissolution, etc.

The addition of additives may be carried out by addition of the additives to the coating composition or depositing additives with desired functionality on the membrane surface.

The membrane may comprise two or more discrete portions of active layers on the substrate.

The membrane of the present invention may be for any type of filtration. Suitably, the membrane of the present invention is for water treatment, such as oil/water separation; molecule separation, pharmaceutical filtration for removal of pharmaceutical residues in the aquatic environment; biofiltration, for example separation between micro-organisms and water; desalination or selective ion filtration; and nuclear waste water filtration for removal of nuclear radioactive elements from nuclear waste water; for blood treatment such as physiological filtration to replace damaged kidney filter and blood filtration; and/or separation of bio-platform molecules derived from sources such as plants, for example a grass. Suitably the membrane is for water treatment, such as desalination or oil and water separation, or for pharmaceutical filtration.

The methods according to any aspect of the present invention may comprise contacting the coating composition onto the substrate using gravity deposition, vacuum deposition, pressure deposition; printing such as inkjet printing, aerosol printing, 3D printing, offset lithography printing, gravure printing, flexographic printing techniques, pad printing; curtain coating, dip coating, spin coating, and other printing or coating techniques known to those skilled in the art.

Suitably the coating composition is a liquid composition comprising a liquid medium and the transition metal dichalcogenide. The coating compositions of the present invention may comprise solvent, non-solvent or solvent-less, and may be UV curable compositions, e-beam curable compositions etc. When formulated as a liquid composition for use in the invention, e.g. as a solution, dispersion or suspension, a suitable carrier liquid or solvent may be aqueous or organic, and other components will be chosen accordingly. For example, the liquid carrier may comprise water or an organic solvent such as ethanol, terpineol, dimethylformamide N-Methyl-2-pyrrolidone, isopropyl alcohol, mineral oil, ethylene glycol, or their mixtures, optionally with other materials to enhance performance and/or rheology of the composition including any one or more of binders, drying additives, antioxidants, reducing agents, lubricating agents, plasticisers, waxes, chelating agents, surfactants, pigments, defoamers and sensitisers.

Surfactants may be used with water or with other liquid as stabiliser to stabilise the transition metal dichalcogenide water dispersion, such as ionic surfactants, non-ionic surfactants and any other surfactants. Preferably, ionic surfactants are used as stabiliser. The stabiliser may be selected from one or more of sodium cholate, sodium dodecyl sulphate, sodium dodecylbenzenesulphonate, lithium dodecyl sulphate, taurodeoxycholate, Triton X-100, TX-100, IGEPAL CO-890, etc. Preferably, sodium cholate and sodium dodecyl sulphate are selected. Other stabiliser could include ethyl cellulose and lithium hydroxide, such as using ethyl cellulose to stabilise exfoliated transition metal dichalcogenide in dimethylformamide.

The liquid carrier, suitably for MoS₂ and WS₂, may be selected from water, ethanol, water/acetone mixtures, water/ethanol mixtures, dimethylformamide, N-Methyl-2-pyrrolidone, isopropyl alcohol, mineral oil, dimethylformamide, terpineol, ethylene glycol, or mixtures thereof, preferably, water/ethanol, such as 50/50 vol % water/ethanol, water optionally with one or more stabiliser, such as lithium oxide; N-methyl-2-pyrrolidone (NMP), or terpineol, most preferably, water:ethanol, such as 50:50 vol % water/ethanol.

Single or few layers transition metal dichalcogenide may be prepared by chemical reaction, intercalation or mechanical exfoliation. Preferably, mechanical exfoliation using a probe or sonication bath, and suitably centrifuge. Preferably, exfoliation using a probe, and suitably the dispersion is then centrifuged. The single or few layers transition metal dichalcogenide can also be obtained from commercial supplier, such as ACS Material.

Centrifuge may be used to remove the aggregated or unexfoliated transition metal dichalcogenide flakes. The spinning speed may be within 100 to 10,000, such as 2000 to 9000, 2500 to 8,000, 3,000 to 7,000, preferably 3,000 to 6,000.

Filtration may be applied to remove aggregated or exfoliated transition metal dichalcogenide flakes.

The active layer may further comprise nanochannels formed by the use of fibres in the production of the membrane. Advantageously the presence of nanochannels within the active layers have been found to significantly increase the water flux by incorporating continuous or chopped fibres having diameter of 0.5-1000 nm during the manufacture process followed by removal of the fibres.

The nanochannels in the active layer may have a diameter of 1 to 750 nm, such as 1 to 500 nm, or 1 to 250 nm, for example 1 to 150 nm or 1 to 100 nm, for example 1 to 50 nm or 1 to 25 nm, such as 1 to 10 nm or preferably 1 to 5 nm.

Suitably, the fibres used to form the nanochannels have a diameter of 1 to 750 nm, such as 1 to 500 nm, or 1 to 250 nm, for example 1 to 150 nm or 1 to 100 nm, for example 1 to 50 nm or 1 to 25 nm, such as 1 to 10 nm, preferably 1 to 5 nm.

The length of the nanostrands may be in a range of from 1 nm to 100 μm, such as 2 nm to 75 μm, or 3 nm to 50 μm, for example 100 nm to 15 μm or 500 nm to 10 μm.

Preferably, the fibres are nanostrands, suitably metal oxide nanostrands. The metal oxide nanostrands may be selected from one or more of Cu(OH)₂, Cd(OH)₂ and Zr(OH)₂.

The fibres, such as the metal oxide nanostands, may be added to the coating composition containing the transition metal dichalcogenide.

The nanostrands may be present in the coating composition in a concentration of from 0.01% to 150% of the transition metal dichalcogenide concentration, such as from 0.01% to 100%, 0.01% to 50%, 0.01% to 20%, preferably 0.01% to 10%.

The nanostrands may be mixed with the transition metal dichalcogenide composition by sonication or mechanical blending. The nanostrands may then be removed, suitably by dissolving using an acid, preferably ethylenediaminetetraacetic acid. Advantageously, the use of metal oxide nanostrands can significantly improve the water flux rate of the membrane whilst maintaining a similar salt/molecule rejection rate.

The coating composition of the present invention may comprise a binder. Suitable binders for use in the composition may be one or more selected from resins chosen from acrylics, acrylates, alkyds, styrenics, cellulose, cellulose derivatives, polysaccharides, polysaccharide derivatives, rubber resins, ketones, maleics, formaldehydes, phenolics, epoxides, fumarics, hydrocarbons, urethanes, polyvinyl butyral, polyamides, shellac, polyvinyl alcohol or any other binders known to those skilled in the art. It has been found that the addition of a binder can advantageously improve the mechanical strength of the membrane and extend the life span.

The coating composition of the present invention may be prepared by dispersing or dissolving one or more components in the liquid using any of mechanical mixing, e.g. leading edge-trailing blade stirring; ceramic ball grinding and milling; silverson mixing; glass bead mechanical milling, e.g. in an Eiger Torrance motormill; Ultra Turrax homogeniser; mortar and pestle grinding; mechanical roll milling.

After the coating composition has been applied to the substrate, the nanostrands may be removed, such as by immersing the membrane in an acidic solution, for example 0.15 M EDTA aqueous solution, suitably, for 20 min followed by washing with deionised water repeatedly.

Preferably, the method according to the present invention comprises deposition, such as pressure deposition, gravity deposition or vacuum deposition of the coating composition comprising the transition metal dichalcogenide onto the substrate.

The concentration of the transition metal dichalcogenide or mixture thereof in a coating composition for deposition may be from 0.001 mg/ml to 10 mg/ml, such as from 0.01 mg/ml to 7 mg/ml or from 0.1 mg/ml to 5 mg/ml, or preferably from 0.1 to 1.5 mg/ml.

Preferably, the substrate for deposition is a porous polymeric film or porous ceramic film or plates.

Preferably, the substrate for deposition is selected from one or more of zeolite, titanium oxide, alumina, zirconia, etc. Preferably, the substrate is selected from one of zeolite, titanium oxide, and zirconia, such as zeolite and zirconia.

The substrate for deposition may be selected from one or more of polyamide (PA), polysulphone (PSf), polyvinylidene fluoride (PVDF), cellulose acetate (CA), tricellulose acetate (TCA), and thin film composites (TFC), such as polysulphone supported polyamide composite film. Preferably, the substrate is selected from one or more of polyamide (PA), polysulphone (PSf), and thin film composite (TFC), such as polysulphone supported polyamide composite film.

The polymeric substrate for deposition may be a treated substrate. A surface of the substrate operable to receive the coating composition may have been subjected to hydrophilisation. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. The grafting of functional groups may be by plasma treatment, redox reaction, radiation, UV-ozone treatment, and/or chemical treatment. Hydrophilic additives may be selected from polyvinyl alcohol, polyethylene glycol, nanofillers, surface modifying macromolecules and zwitterions. The addition of hydrophilic additives may be carried out by coating or depositing additives with desired functionality on the membrane surface.

Advantageously, the presence of said hydrophilicity and/or functionality on the polymeric substrate for vacuum/gravity/pressure deposition provides an active layer having a more uniform structure and improved continuity. The said hydrophilicity and/or functionality may also provide improved filter life span and stability.

The viscosity of the coating composition for deposition may be from 1 to 100 cPa, preferably 1 to 50 cPa, such as 5 to 40 cPa.

The surface tension of the coating composition for deposition may be from 1 to 150 mN/m, such as from 25 to 80 mN/m.

The combination of preferred viscosity and surface tension provide high wettability and uniform deposition of the transition metal dichalcogenide flakes onto substrate.

Advantageously, the coating compositions of the present invention for deposition can provide high stability for a prolonged period. A solvent of water/ethanol mixture has been found to provide improved stability. In particular, a water dispersion with stabiliser has been found to provide significantly improved stability.

The deposition coating method may be gravity deposition, pressure deposition, and vacuum deposition, for example pressure deposition using pressure of at least 0.5 bar or 1 bar gauge pressure, preferably the pressure deposition or vacuum deposition.

The deposition method may comprise the coating composition being passed through the substrate by gravity, applying pressure or vacuum suction, suitably to form layers of transition metal dichalcogenide membrane on top of the substrate.

The thickness of the active layer deposited on the substrate with deposition may be controlled by the concentration of the dispersion at a fixed volume, for example 100 ml of 0.001 mg/ml for the deposited area of 16 cm² gives an average thickness of 5 nm.

The thickness of the active layer for deposition may be at least 3 nm, such as at least 5 nm or at least 10 nm. The deposition may apply the active layer with multiple times or with higher concentration.

Preferably, the method according to the present invention comprises inkjet printing the coating composition onto the substrate.

Preferably, the substrate for printing is a porous polymeric film, more preferably a polymeric porous substrate treated prior to the addition of the coating composition. Advantageously, a substrate in the form of a porous polymeric film can provide improved ease in processing and/or lower cost.

The substrate for printing may be selected from one or more of polyamide (PA), polysulphone (PSf), polyvinylidene fluoride (PVDF), cellulose acetate (CA), tricellulose acetate (TCA) and thin film composites (TFC), such as polysulphone supported polyamide composite film. Preferably, the substrate is selected from one or more of polyamide (PA), polysulphone (PSf), and thin film composite (TFC), such as polysulphone supported polyamide composite film.

The substrate for printing may be a treated substrate. A surface of the substrate operable to receive the coating composition may have been subjected to hydrophilisation. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. The grafting of functional groups may be by plasma treatment, redox reaction, radiation, UV-ozone treatment, and/or chemical treatment. Hydrophilic additives may be selected from polyvinyl alcohol, polyethylene glycol, nanofillers, surface modifying macromolecules and zwitterions. The addition of hydrophilic additives may be carried out by coating or depositing additives with desired functionality on the membrane surface.

Advantageously, the presence of said hydrophilicity and/or functionality on the substrate for printing provides an active layer having a more uniform structure and improved continuity. The said hydrophilicity and/or functionality may also provide improved filter life span and stability.

The concentration of the transition metal dichalcogenide in the coating composition for printing may be from 0.05 mg/ml to 4 mg/ml, such as from 0.1 mg/ml to 3 mg/ml or from 0.3 mg/ml to 2 mg/ml, or preferably from 0.5 to 2 mg/ml. When the concentration is too low, such as lower than 0.05 mg/ml, leakage of the ink from the cartridge could occur, and when the concentration is too high, such as higher than 4 mg/ml, the dispersion shows high viscosity which is not suitable for printing.

The diameter of nanostrands for printing may be from 1 to 100 nm, preferably from 1 to 50 nm, more preferably from 1 to 10 nm.

The length of the nanostrands for printing may range from 2 nm to 10 μm. Preferably, from 100 nm to 10 μm, preferably from 200 nm to 10 μm. When the length is too long, it may cause the blockage to the nozzle, and when the length is too short, only caves may be generated. The coating composition may contain metal oxide nanostrands which could significantly increase the water flux rate whilst maintaining a similar salt/molecule rejection rate.

The viscosity of the coating composition for printing may be from 1 to 14 cPa, preferably 5 to 15 cPa, such as 10 to 12 cPa.

The surface tension of the coating composition for printing may be from 1 to 150 mN/m, such as from 25 to 80 mN/m.

The composition for printing may have a Z number of between 1 and 16. Said Z number is calculated according to the formula Z=√γρα/μ, in which μ is the viscosity of the coating composition (mPas), γ is the surface tension of the coating composition (mJ/m2), ρ is the density of the coating composition (g/cm-3), and α is the nozzle diameter of the inkjet printer head (μm).

Advantageously, the coating compositions of the present invention for printing can provide high stability for a prolonged period. Furthermore, a concentration of <0.5 mg/ml has been found to give good droplet uniformity and stable jetting.

Suitably, the printing method is inkjet printing, such as drop on demand (DOD) inkjet printing, for example piezoelectric or thermal; or continuous inkjet printing (CIJ), preferably the inkjet printing is DOD inkjet printing.

The nozzle size of the inkjet printer may be from 5 μm to 100 μm, preferably from 5 μm to 60 μm.

The average size of the transition metal dichalcogenide for printing may be ≤ 1/10 of the nozzle size, such as ≤ 1/15 of the nozzle size. For example, for nozzle having diameter of 20 um, the flake may have a size of ≤2 um. Such a ratio of flake size to nozzle size can advantageously provide reduced nozzle blockage.

The cartridge drop volume may be from 1 pl to 100 pl, suitably from 5 to 50 pl, or from 8 to 30 pl, such as 10 pl. The voltage and firing frequency of the inkjet printing method may depend on the waveform of the coating composition. The firing voltage may be from 10 to 30 V. The firing frequency may be from 3 kHz to 15 kHz, suitably about 5 KHz. The cartridge temperature of the inkjet printer may be from 20° C. to 50° C., suitably about 40° C. The stage temperature of the inkjet printer may be from 20° C. to 60° C., suitably about 21° C.

A raster with stochastic filters may be used during the printing processes. Advantageously, the use of said raster reduces overlapping of the transition metal dichalcogenide or mixture thereof and can provide improved homogeneous printing.

A sheet of clean room paper may be placed on the platen to reduce vacuum localisation.

The thickness of the active layer deposited by each pass of the inkjet printer may be at least 3 nm, such as at least 4 nm or at least 5 nm. The inkjet printing may apply the active layer with multiple passes.

Advantageously, the method of the present invention provides a time efficient method for producing active layers on a substrate that are of a controllable thickness, and allows for low thicknesses to be achieved. The method of the present invention advantageously produces improved uniformity in the active layer. The method of the present invention is scalable to allow for improved production of large numbers of membranes.

For application by other printing methods as detailed earlier, optimum parameters will be known to those skilled in the art. For example, for application by Flexography or gravure, the liquid composition should have a viscosity in the range of 15-35 s Din #4 flow cup and a drying rate tailored to suit the substrate and print speed.

The filtration membranes according to the aspects of the present invention may be utilised in a wide range of architectures and filtration devices, including but not limited to those working under gravity filtration, vacuum filtration and/or pressurised systems.

The term lamellar structure herein means a structure having at least two overlapping layers. The term active layer herein means a layer operable to provide filtration across the layer. The term two-dimensional material herein means a material with at least one dimension of less than 100 nm.

For a better understanding of the invention, and to show how embodiments of the same may be carried into effect, reference will now be made, by way of example, to the following experimental data.

### EXAMPLES

Example 1: 1 kg molybdenum disulfide was immersed in butyllithium solution in hexane for 48 hours in an atmosphere of argon. The mixture was then filtered and washed with hexane. Exfoliation was achieved after the residue was added with 10 g sodium cholate and sonicated in water and centrifuged at 4000 rpm a couple of times. The dispersion was then diluted to a concentration of 0.5 mg/ml for coating. The obtained dispersion was then applied to polysulphone substrate which was surface treated with UV-ozone for 20 min, using a Pixdro LP50 equipped with Xaar 1002 head assembly. Following drying under ambient conditions, the performance of the resultant membrane was then assessed and found to exhibit improvement of multi-valent ions rejection rate to 90% in comparison to an uncoated membrane.

Example 2: An initial MoS₂ concentration of 1 mg/ml was made by dispersing MoS₂ in a sodium cholate/water solution of surfactant concentration of 0.05 mg/ml in a stainless vessel by probe sonication (750 W at 40-75% amplitude) for 25 min. The dispersion was then settled for 2 hours and the top layer of the dispersion was then decanted and centrifuged at rpm of 3000 for 10 mins. The resultant dispersion was then diluted to a concentration of 0.5 mg/ml and deposited on a porous membrane using vacuum deposition. The material was then dried at room temperature. The performance of the resultant membrane was assessed and found to exhibit an improvement of at least 40% of water flux rate versus an uncoated membrane with salt rejection of 90%.

Example 3: An initial MoS₂ concentration of 1 mg/ml was made by dispersing MoS₂ in a sodium cholate/water solution of surfactant concentration of 0.05 mg/ml in a stainless vessel by probe sonication (750 W at 40-75% amplitude) for 25 mins. The dispersion was then settled for 2 hours and the top layer of the dispersion was then decanted and centrifuged at rpm of 3000 for 25 mins. Cu(OH)₂ nanostrands of 1% weight equivalent to MoS₂ was then added to the dispersion and mixed with magnetic stirring. The resultant dispersion was then diluted to a concentration of 0.2 mg/ml and deposited on a porous membrane using vacuum deposition. Ethylenediaminetetraacetic acid water solution was filtered to remove the nanostrands and create nanochannels, followed by filtration of deionised water to remove any residual acid. The material is then dried at room temperature. The performance of the resultant membrane was assessed and found to exhibit an improvement of at least 100% of water flux rate compared to an uncoated membrane, and improvement of ion rejection of 90% compared to 0% of an uncoated membrane.

Example 4: An initial MoS₂ concentration of 1 mg/ml was made by dispersing MoS₂ in a sodium cholate/water solution of surfactant concentration of 0.05 mg/ml in a stainless vessel by probe sonication (750 W at 40-75% amplitude) for 30 mins. The dispersion was then settled for 2 hours and the top layer of the dispersion was then decanted and centrifuged at rpm of 3000 for 10 mins. Zr(OH)₂ nanostrands having length of <5 um and weight equivalent of 1% to MoS₂ was added to the dispersion and mixed with magnetic stirring. The obtained dispersion was then applied to surface treated polysulphone (UV-ozone, 20 min) using a Pixdro LP50 equipped with Xaar 1002 head assembly having nozzle size of 60 um. Ethylenediaminetetraacetic acid water solution was filtered to remove the nanostrands and create nanochannels, followed by filtration of deionised water to remove any residual acid. The material was then dried at room temperature. The performance of the resultant membrane was assessed and found to exhibit an improvement of over 100% of water flux rate compared to an uncoated membrane, and improvement of ion rejection of 90% compared to 0% of an uncoated membrane.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A filtration membrane comprising a porous substrate layer and an active layer arranged over at least a part of the substrate layer, wherein the active layer has a lamellar structure comprising at least two layers of two-dimensional material, and wherein the two-dimensional material comprises transition metal dichalcogenide

2. A method of producing a filtration membrane according to claim 1, wherein the membrane comprises a porous substrate layer and an active layer arranged over at least a part of the substrate layer, wherein the active layer has a lamellar structure comprising at least two layers of two dimensional material, and wherein the two-dimensional material comprises transition metal dichalcogenide, the method comprising the steps of:
a. optionally preparing the substrate
b. contacting the substrate with a coating composition comprising the transition metal dichalcogenide;
c. optionally, drying the membrane.

3. The filtration membrane according to claim 1, wherein the membrane is obtained by:
a. optionally preparing the substrate
b. contacting the substrate with a coating composition comprising the transition metal dichalcogenide;
c. optionally, drying the membrane.

4. The filtration membrane according to claim 3, wherein contacting comprises printing the coating composition comprising the transition metal dichalcogenide onto the substrate.

5. (canceled)

6. (canceled)

7. The filtration membrane according to claim 1, wherein the substrate comprises a porous film, porous plate, hollow fibres, or bulky shapes.

8. The filtration membrane to claim 7, wherein the substrate is formed from materials selected from one or more of zeolite, silicon, silica, alumina, zirconia, mullite, bentonite and montmorillonite clay substrate.

9. (canceled)

10. (canceled)

11. (canceled)

12. (canceled)

13. The filtration membrane according to claim 1, wherein the substrate comprises a porous polymeric film.

14. The filtration membrane according to claim 1, wherein the substrate is formed from materials selected from one or more of polyamide (PA), polysulphone (PSf), polyvinylidene fluoride (PVDF) and thin film composites (TFC).

15. (canceled)

16. (canceled)

17. The filtration membrane according to claim 1, wherein the support is ultrafiltration in which a pore size of the substrate layer is from 0.1 nm to 4000 nm.

18. (canceled)

19. (canceled)

20. The filtration membrane according to claim 1, wherein the substrate has a surface roughness of from 0 to 1 μm.

21. The filtration membrane according to claim 1, wherein the surface of the substrate that comprises the active layer is hydrophilic.

22. (canceled)

23. (canceled)

24. The filtration membrane according to claim 1, wherein the active layer has a thickness of from 2 nm to 1 μm.

25. The filtration membrane according to claim 1, wherein the transition metal dichalcogenide is according to formula (I)
MₐX_{b}, (I)
wherein with M is a transition metal atom;
X is a chalcogen atom;
wherein 0<a≤1 and 0<b≤2.

26. (canceled)

27. The filtration according to claim 1, wherein the transition metal dichalcogenide is selected from MoS₂, WS₂, MoSe₂, WSe₂.

28. The filtration membrane according to claim 1, wherein the transition metal dichalcogenide is in the form of flakes having an average size of from 1 nm to 5000 nm.

29. The filtration membrane according to claim 1, wherein the size distribution of the transition metal dichalcogenide flakes is such that at least 30 wt % of the transition metal dichalcogenide flakes have a diameter of between 1 nm to 5000 nm.

30. (canceled)

31. The filtration membrane according to claim 1, wherein the average size of the transition metal dichalcogenide is at least 80% of the average pore size of the substrate.

32. (canceled)

33. (canceled)

34. (canceled)

35. The filtration membrane according to claim 1, wherein the active layer further comprises nanochannels.

36. The filtration membrane according to claim 1, wherein the nanochannels in the active layer have a diameter of 1 to 750 nm.

37. (canceled)

38. The filtration membrane according to claim 1, wherein the membrane is configured for water treatment.

39. (canceled)

40. (canceled)

41. (canceled)

42. (canceled)

43. (canceled)

44. The filtration membrane according to claim 43, wherein the composition comprises a surfactant is selected from one or more of sodium cholate, sodium dodecyl sulphate, sodium dodecylbenzenesulphonate, lithium dodecyl sulphate, taurodeoxycholate, ethyl cellulose, lithium hydroxide, Triton X-100, TX-100, IGEPAL CO-890.

45. (canceled)

46. (canceled)

47. (canceled)

48. The filtration membrane according to claim 3, wherein coating composition comprises fibres.

49. The filtration according to claim 48, wherein the fibres are present in the coating composition in a concentration of from 0.01% to 150% of the transition metal dichalcogenide concentration.

50. (canceled)

51. (canceled)

52. (canceled)

53. The filtration membrane according to claim 3, wherein contacting comprises deposition and the concentration of the transition metal dichalcogenide in the coating composition for deposition is from 0.001 mg/ml to 10 mg/ml.

54. (canceled)

55. (canceled)

56. The filtration membrane according to claim 3, wherein the viscosity of the coating composition is from 1 to 100 cPa.

57. The filtration membrane according to claim 3, wherein the surface tension of the coating composition is from 1 to 150 mN/m.

58. (canceled)

59. (canceled)

60. (canceled)

61. The filtration membrane according to claim 3, wherein the concentration of the transition metal dichalcogenide in the coating composition is from 0.05 mg/ml to 4 mg/ml.

62. (canceled)

63. (canceled)

64. (canceled)

65. (canceled)

66. The filtration membrane according to claim 3, wherein the coating composition has a Z number of between 1 and 16.

67. The filtration membrane according to claim 4, wherein the printing is drop on demand (DOD) inkjet printing.

68. The filtration membrane according to claim 67, wherein the nozzle size of the inkjet printer is from 5 um to 100 um.

69. A filtration device comprising the filtration membrane according to claim 1.

70. The filtration device according to claim 69, wherein the filtration device is a gravity filtration device.
